(19) United States
(12) Patent Application Publication
(10) Pub. No.: US 2009/0047494 A1
(43) Pub. Date: Feb. 19, 2009

(54) Vinylidene chloride - methyl acrylate copolymer resin composition and film comprising the resin composition

(75) Inventors: Ryoko Hirata, Tokyo (JP); Katsuhiko Usui, Tokyo (JP); Tadayoshi Matsumura, Tokyo (JP)

Correspondence Address: STAAS & HALSEY LLP, SUITE 700, 1201 NEW YORK AVENUE, N.W., WASHINGTON, DC, 20005, US

(73) Assignee: Asahi Kasei Chemicals Corporation, Tokyo (JP)

(21) Appl. No.: 11/902,048

(22) Filed: Sep. 18, 2007

Related U.S. Application Data
(60) Provisional application No. 60/845,535, filed on Sep. 19, 2006.

(51) Int. Cl. C08K 5/1545; B32B 27/00

(52) U.S. Cl. 428/220; 524/110

(57) ABSTRACT

The present invention provides a novel vinylidene chloride resin composition that excels in thermal stability and enables the extrusion of films at a high extrusion rate; a biaxially stretched film that is manufactured from the vinylidene chloride resin composition and excels in barrier properties and transparency; and a multilayer film including the stretched film. The copolymer resin composition contains a vinylidene chloride-methyl acrylate copolymer resin that has a content ratio of methyl acrylate component of no less than 4 wt. % and no more than 6 wt. % and a weight-average molecular weight, determined by gel permeation chromatography, of no less than 60,000 and no more than 80,000 and contains as additives predetermined volumes of: (a) an epoxidized vegetable oil; (b) 2,6-di-tert-butyl-4-methylphenol; (c) dl-α-tocopherol; (d) a thiodifatty acid dialkyl ester; and (e) an ethylenediaminetetraacetic acid salt.

### BACKGROUND

The present invention relates to a novel vinylidene chloride resin composition that excels in thermal stability and enables the extrusion films at a high extrusion rate and also to a biaxially stretched film that is manufactured from this vinylidene chloride resin composition and excels in barrier properties and transparency and a multilayer film including the stretched film. A laminated film containing the film in accordance with the present invention as a core material demonstrates good barrier properties and can be used as a packaging material for medical goods, medical devices, and food such as retort food, frozen food, seasonings, hard candies, processed meat and marine products, and seasoned cooked food.

Biaxially stretched films manufactured from copolymer resins of vinylidene chloride and methyl acrylate demonstrate excellent gas barrier properties, moisture resistance, transparency, chemical stability, and resistance to oils. Accordingly, they have been laminated with paper, metal foils such as aluminum foils, and various synthetic resin films such as polyethylene, polypropylene, polyesters, polyamides, polyvinyl alcohol, and polyvinyl chloride for use as packaging materials for a variety of food and medical goods of different kinds. However, in order to preserve barrier properties that are a strong feature of vinylidene chloride-methyl acrylate copolymer films, only a very small amount of additives can be added to the resin. As a result, thermal stability during film extrusion is very poor and productivity has to be sacrificed.

Japanese Patent Application Laid-open No. 61-120719 describes a method for molding a resin of a vinylidene chloride-methyl acrylate copolymer that has a content ratio of methyl acrylate component of 3 to 15 wt. % and a weight-average molecular weight of 70,000 to 250,000, and contains a low-molecular copolymer with a molecular weight of 20,000 or less at a specific ratio. However, with the combination of methyl acrylate and epoxidized linseed oil (ELO) and magnesium oxide (MgO) as thermal stabilizers and the content ratio thereof described in the specification of the aforementioned Japanese Patent Application Laid-open No. 61-120719, although the target barrier level can be maintained, a sufficient thermal stability is very difficult to obtain at a high extrusion rate, and an extrusion rate is limited to about 100 kg/hr. Where the extrusion rate is increased, shear heat generation in the resin inside the extruder becomes significant, causing intensive thermal degradation and making the industrial production impossible. Yet another problem is that in order to ensure that a component with a molecular weight of 20,000 or less is contained at above a certain level, while maintaining the average molecular weight, it is sometimes necessary to blend a polymerized resin separately, thereby complicating the process.

Japanese Patent Application Laid-open No. 62-267332 describes a biaxially stretched film comprising a vinylidene chloride-methyl acrylate copolymer with a content ratio of a plasticizer of 1 wt. % or less, in which ELO is used alone as a thermal stabilizer. Where the content ratio of a plasticizer is within the aforementioned range, barrier properties of the film can be maintained, but thermal stability during melt extrusion is insufficient and the extrusion rate of resin during film production is limited to about 100 kg/hr.

For example, a combination of tetrakis[methylene-3-(3,5-di-tert-butyl-4-hydroxyphenyl)propionate] and citric acid or an alkali metal salt of citric acid (see Japanese Patent Application Laid-open No. 8-165394), octadecyl-3-(3,5-di-tert-butyl-4-hydroxyphenyl)propionate (see Japanese Examined Patent Publication No. 57-10894), a combination of triethylene glycol-bis[3-(3-tert-butyl-4-hydroxy-5-methylphenyl)propionate] and sodium pyrophosphate (see Japanese Examined Patent Publication No. 6-18963), and a combination of vitamin E, an alkyl ester of thiopropionic acid, and an inorganic phosphate (see Japanese Examined Patent Publication No. 61-26813), a combination of vitamin E and an ethylenediaminetetraacetate (see Japanese Examined Patent Publication No. 1-990) are known as effective thermal stabilizers. However, thermal stability of resin compositions comprising such thermal stabilizers is still insufficient, and although an effect is demonstrated in terms of color b value of a sheet after hot pressing, significant thermal degradation occurs at an extrusion rate of about 300 kg/hr.

Where a large quantity of a powdered thermal stabilizer is used, barrier performance of the produced film can be maintained, but transparency of the film is degraded. According to another method, shear heat generation during melt extrusion is decreased by reducing molecular weight and thermal degradation is inhibited by enabling the extrusion at a low temperature. However, where the molecular weight is below a certain level, mechanical strength of the film decreases and stretching during film formation is impossible.

### SUMMARY

It is an object of the present invention to provide a novel vinylidene chloride resin composition that excels in thermal stability and is suitable for extruding films at a high extrusion rate, a biaxially stretched film that is manufactured from the vinylidene chloride resin composition and excels in barrier properties and transparency, and a multilayer film including the stretched film.

The inventors have conducted a comprehensive study of vinylidene chloride-methyl acrylate copolymer resin compositions, and the results obtained demonstrated that a film having thermal stability and good barrier prosperities and transparency after film production can be manufactured at an extrusion rate of about 300 kg/hr by selecting a specific combination of additives and resin. This finding led to the creation of the present invention.

The present invention is described below.

(1) A vinylidene chloride-methyl acrylate copolymer resin composition comprising a vinylidene chloride-methyl acrylate copolymer resin that has a content ratio of methyl acrylate component of no less than 4 wt. % and no more than 6 wt. % and a weight-average molecular weight, determined by gel permeation chromatography, of no less than 60,000 and no more than 80,000 and comprising as additives: (a) an epoxidized vegetable oil at no less than 0.1 wt. % and no more than 1.0 wt. %; (b) 2,6-di-tert-butyl-4-methylphenol at no less than 0.005 wt. % and no more than 0.05 wt. %; (c) dl-α-tocopherol at no less than 0.001 wt. % and no more than 0.05 wt. % or less; (d) a thiodifatty acid dialkyl ester at no less than 0.005 wt. % and no more than 0.5 wt. %; and (e) an ethylenediaminetetraacetic acid salt at no less than 0.001 wt. % and no more than 0.05 wt. %.

(2) The resin composition according to (1) above, wherein the epoxidized vegetable oil that is the additive (a) is selected from epoxidized linseed oil, epoxidized soybean oil, and mixtures thereof.

(3) The resin composition according to (1) above, wherein the thiodifatty acid dialkyl ester that is the additive (d) is selected from dilauryl thiodipropionate, distearyl thiodipropionate, and mixtures thereof.

(4) The resin composition according to (1) above, wherein the ethylenediaminetetraacetic acid salt that is the additive (e) is disodium salt of ethylenediaminetetraacetic acid.

(5) The resin composition according to (1) above, further comprising as additives: (f) a fatty acid amide at no less than 0.01 wt. % and no more than 0.1 wt. % and (g) an inorganic lubricant at no less than 0.001 wt. % and no more than 0.1 wt. %.

(6) A biaxially stretched film of vinylidene chloride-methyl acrylate copolymer that is obtained by stretching the resin composition according to (1) above, wherein an oxygen transmission rate is no less than 50 mL·μm/m²·day·MPa and no more than 400 mL·μm/m²·day·MPa and a water vapor transmission rate is no less than 5 g·μm/m²·day and no more than 40 g·μm/m²·day.

(7) A biaxially stretched film of vinylidene chloride-methyl acrylate copolymer that is obtained by stretching the resin composition according to (1) above, wherein a HAZE value of the biaxially stretched film with a thickness of 25 μm is less than 10% after the film is subjected to retort treatment.

(8) A multilayer structure comprising at least one layer of the biaxially stretched film according to (6) or (7) above.

(9) The multilayer structure according to (8) above, wherein the structure is a film or a sheet.

The present invention can provide a new vinylidene chloride resin composition that excels in thermal stability and is suitable for extruding films at a high extrusion rate, a biaxially stretched film that is manufactured from the vinylidene chloride resin composition and excels in barrier properties and transparency, and a multilayer film or sheet including the stretched film.

### DESCRIPTION OF THE DRAWING

FIG. 1 is a schematic drawing illustrating an example of an apparatus for manufacturing a film by extruding a vinylidene chloride-methyl acrylate copolymer film.

### DETAILED DESCRIPTION

The present invention will be described below in greater details.

The vinylidene chloride-methyl acrylate copolymer resin composition in accordance with the present invention comprises a copolymer resin composed of vinylidene chloride and methyl acrylate. The methyl acrylate component of the copolymer composition is contained at 4 wt. % to 6 wt. %, preferably 4.7 wt. % to 5.7 wt. %, and the vinylidene chloride component is contained at 94 wt. % to 96 wt. %, preferably 94.3 wt. %. to 95.3 wt. %. Where the content ratio of the methyl acrylate component is 4 wt. % or more and also when the below-described weight-average molecular weight and additives satisfy the predetermined requirements, thermal stability during melt extrusion is good, and where the content ratio of the methyl acrylate component is 6 wt. % or less and also when the below-described additives satisfy the predetermined requirements, the film produced has good barrier properties.

The weight-average molecular weight (Mw) of vinylidene chloride-methyl acrylate copolymer resin composition in accordance with the present invention found by gel permeation chromatography (GPC method) by using polystyrene as a standard is 60,000 or more and 80,000 or less, preferably 67,000 or more and 77,000 or less. Where Mw is 60,000 or more, the film produced has a strength sufficient to withstand stretching, and where Mw is 80,000 or less and also when the above-described content ratio of methyl acrylate and the below-described additives satisfy the predetermined requirements, it is possible to obtain a resin composition with good thermal stability during melt extrusion.

The vinylidene chloride-methyl acrylate copolymer resin composition in accordance with the present invention comprises as additives: (a) an epoxidized vegetable oil at 0.1 wt. % to 1.0 wt. %; (b) 2,6-di-tert-butyl-4-methylphenol (BHT) at 0.005 wt. % to 0.05 wt. %; (c) dl-α-tocopherol (vitamin E) at 0.001 wt. % to 0.05 wt. %; (d) a thiodifatty acid dialkyl ester at 0.005 wt. % to 0.5 wt. %; and (e) an ethylenediaminetetraacetic acid salt at 0.001 wt. % to 0.05 wt. %. The preferred respective content ratios are as follows: (a) 0.4 wt. % to 1.0 wt. %, (b) 0.01 wt. % to 0.04 wt. %, (c) 0.003 wt. % to 0.03 wt. %, (d) 0.01 wt. % to 0.3 wt. %, and (e) 0.002 wt. % to 0.02 wt. %. The content ratio in “wt. %” hereinabove is found based on the entire weight of the resin composition.

The (a) epoxidized vegetable oil is preferably epoxidized linseed oil (ELO), epoxidized soybean oil (ESO), or a mixture thereof.

The (d) thiodifatty acid dialkyl ester is preferably dilauryl thiodipropionate (DLTDP), distearyl thiodipropionate (DSTDP), or a mixture thereof.

The (e) ethylenediaminetetraacetic acid salt is preferably a salt of EDTA and an alkali metal such as disodium salt of ethylenediaminetetraacetic acid (EDTA-2Na), a salt of EDTA and an alkaline earth metal, EDTA zinc, or a mixture thereof.

Where the (a) epoxidized vegetable oil is contained at 0.1 wt. % or more and the above-described content ratio of methyl acrylate component and weight-average molecular weight and the below-described additives satisfy the predetermined condition, thermal stability during melt extrusion of the resin is good. Where the epoxidized vegetable oil is contained at 1.0 wt. % or less, and the above-described content ratio of methyl acrylate component satisfies the predetermined condition, the film produced demonstrates good barrier properties.

Where the (b) 2,6-di-tert-butyl-4-methylphenol (BHT) is contained at 0.005 wt. % or more and the above-described content ratio of methyl acrylate component and weight-average molecular weight and also other additives satisfy the predetermined condition, thermal stability during melt extrusion is good. In particular, an effect is demonstrated in reducing the color b value (degree of yellowing) of the produced film. A high b value indicates that yellowing is significant and thermal degradation reached an advanced state. Where the content ratio of BHT is 0.05 wt. % or less, the occurrence of voids caused by BHT as a powder additive is reduced even when the produced film is subjected to retort treatment, and the film transparency is good.

Where the (c) dl-α-tocopherol (vitamin E) is contained at 0.001 wt. % or more and the above-described content ratio of methyl acrylate component and weight-average molecular weight and also other additives satisfy the predetermined condition, thermal stability during melt extrusion is good. In particular, an effect is demonstrated in reducing the color b value of the produced film. Further, where vitamin E is contained at 0.05 wt. % or less, the produced film has no yellow color that is the color of vitamin E itself. In addition, due to a synergetic effect of (b) BHT and (c) vitamin E, the effect of inhibiting the b value of the film is further enhanced. In order to obtain the same effect with each component individually, a large quantity thereof has to be used, but a problem of retort whitening is associated with BHT, whereas a problem of film yellowing is associated with vitamin E. Where the two are added together, sufficient inhibition of the b value can be attained with the above-described quantities of the additives.

Where the (d) thiodifatty acid dialkyl ester is contained at 0.005 wt. % or more and the above-described content ratio of methyl acrylate component and weight-average molecular weight and also other additives satisfy the predetermined condition, thermal stability during melt extrusion is good. In particular, sliding of the molten resin against the die parts during melt extrusion is improved, whereby contamination is inhibited and die wiping interval can be extended. Where the thiodifatty acid dialkyl ester is contained at 0.5 wt. % or less, the occurrence of voids caused by the thiodifatty acid dialkyl ester as a powder additive is reduced even when the produced film is subjected to retort treatment, and the film transparency is good.

Where the (e) ethylenediaminetetraacetic acid salt is contained at 0.001 wt. % or more, the impurity metals contained in the resin are included in the molecules by a chelating effect. Therefore, the amount of carbon-like foreign matter derived from impurity metals in the produced film is reduced. Where a large amount of foreign matter is admixed in the usual production process, the number of times the film is spliced to remove the foreign matter is increased and the film product grade is reduced, but this can be inhibited by the effect of the ethylenediaminetetraacetic acid salt. Further, where the ethylenediaminetetraacetic acid salt is contained at 0.05 wt. % or less, the occurrence of voids caused by the ethylenediaminetetraacetic acid salt as a powder additive is reduced even when the produced film is subjected to retort treatment, and the film transparency is good.

In particular, thermal stability during melt extrusion was found to improve dramatically due to a synergetic effect of these (a) to (e) additives, and the film could be produced with good stability even at an extrusion rate of 300 kg/hr. Even if one of these five (a) to (e) additives is missing, a sufficient thermal stability effect is not demonstrated at an extrusion rate of 300 kg/hr.

The vinylidene chloride-methyl acrylate copolymer resin composition in accordance with the present invention preferably contains 0.01 wt. % to 0.1 wt. % a fatty acid amide and 0.001 wt. % to 0.1 wt. % an inorganic lubricating agent as lubricants, and it is even more preferred that the fatty acid amide be contained at 0.02 wt. % to 0.08 wt. % and the inorganic lubricating agent be contained at 0.005 wt. % to 0.05 wt. %. The content ratio in “wt. %” hereinabove is found based on the entire weight of the resin composition.

Examples of suitable (f) fatty acid amides include palmitic acid amide, stearic acid amide, erucic acid amide, oleic acid amide, behenic acid amide, ethylenebisstearic acid amide, lauric acid amide, and myristic acid amide. Among them, palmitic acid amide, stearic acid amide, and erucic acid amide are especially preferred. These compounds may be used individually or in mixtures. Where the content ratio of the fatty acid amide is 0.01 wt. % or more, then the fatty acid amide in combination with the below-described inorganic lubricant ensure good sliding properties of the produced film and improve lamination processability, and where the content ratio of the fatty acid amide is 0.1 wt. % or less, excessive bleed-out to the film surface is inhibited, and adhesive strength during lamination with other substrate in subsequent processing is improved.

A fine solid powder can be used as the (g) inorganic lubricant, examples of such powders include metal oxides, metal hydroxides, metal carbonates, metal sulfates, metal silicates, metal phosphates, metal metaphosphates, and other natural minerals. The preferred among them are silica, magnesium oxide, talc, calcium carbonate, mica, and nepheline. These compounds may be used individually or in mixtures. Where the content ratio of the inorganic lubricant is 0.001 wt. % or more, then the inorganic lubricant in combination with the above-described fatty acid amide ensure good sliding properties of the produced film and improve lamination processability, and where the content ratio of the inorganic lubricant is 0.1 wt. % or less, the occurrence of voids caused by the inorganic compound as a powder additive is reduced even when the produced film is subjected to retort treatment, and the film transparency is good.

The present invention also provides a biaxially stretched film manufactured from the above-described vinylidene chloride-methyl acrylate copolymer resin composition in accordance with the present invention.

An oxygen transmission rate of the biaxially stretched film manufactured from the above-described vinylidene chloride-methyl acrylate copolymer resin composition in accordance with the present invention is no less than 50 mL·μm/m²·day·MPa and no more than 400 mL·μm/m²·day·MPa and a water vapor transmission rate is no less than 5 g·μm/m²·day and no more than 40 g·μm/m²·day.

The oxygen transmission rate and water vapor transmission rate of the film can be adjusted by changing the content ratio of the methyl acrylate component in the vinylidene chloride-methyl acrylate copolymer and the content ratio of additive (a) in the copolymer resin composition. Where the content ratio of the methyl acrylate component in the copolymer is no less than 4 wt. % and no more than 6 wt. % and the content ratio of additive (a) is no less than 0.1 wt. % and no more than 1.0 wt. %, the oxygen transmission rate will be 50 mL·μm/m²·day·MPa or more and the water vapor transmission rate will be 5 g·μm/m²·day or more.

Further, for example, where the content ratio of the methyl acrylate component is no less than 5.5 wt. % and no more than 6 wt. %, by selecting a suitable quantity of additive (a) that is 0.8 wt. % or less, the oxygen transmission rate can be made 400 mL·μm/m²·day·MPa or less and the water vapor transmission rate can be made 40 g·μm/m²·day or less and good barrier properties can be obtained.

The transparency of the biaxially stretched film manufactured from the above-described vinylidene chloride-methyl acrylate copolymer resin composition in accordance with the present invention is preferably less than 10%, or even preferably less than 7% at to the HAZE value after retort processing of 25 μm thick film. If the HAZE value is less than 10%, the transparency after retort processing is satisfactory and can be applied for items that require transparent film packaging.

The thickness of the biaxially stretched film manufactured from the above-described vinylidene chloride-methyl acrylate copolymer resin composition in accordance with the present invention is preferably 10 μm to 100 μm, more preferably 15 μm to 50 μm. Where the thickness is 10 μm or more, sufficient barrier performance is obtained for the entire thickness, and where the thickness is 100 μm or less, productivity during film extrusion is good.

The biaxially stretched film manufactured from the above-described vinylidene chloride-methyl acrylate copolymer resin composition in accordance with the present invention is laminated with paper, metal foils such as aluminum foils, and various synthetic resin films such as polyethylene, polypropylene, polyesters, polyamides, polyvinyl alcohol, and polyvinyl chloride. Among those materials, CPP, LLDPE, 6-Ny, 66-Ny, PET, and PVC are preferably used. Examples of preferred lamination methods include dry lamination, wet lamination, and extrusion lamination methods.

The present invention provides also a multilayer structure comprising at least one layer of the biaxially stretched film according to the present invention. The multilayer structure is selected from, for example, a multilayer film and a multilayer sheet.

Examples of methods suitable for the manufacture of the vinylidene chloride-methyl acrylate copolymer resin in accordance with the present invention include a suspension polymerization method, an emulsion polymerization method, and a solution polymerization method. Among them, suspension polymerization is preferred. Examples of suspension polymerization method include a direct suspension method in which monomers are added to water in which a suspending agent is dissolved and a suspension method in which, as described in Japanese Patent Application Laid-open No. 62-280207, water with a suspending agent dissolved therein is added to monomers, and a dispersion with monomers as a discontinuous phase and water as a continuous phase is obtained via a dispersion state with monomers as a continuous phase and water as a discontinuous phase.

Examples of oil-soluble initiators that are used in the manufacture of the vinylidene chloride-methyl acrylate copolymer resin in accordance with the present invention by suspension polymerization include organic peroxides such as lauroyl peroxide, benzoyl peroxide, tert-butylperoxy-2-ethylhexanoate, tert-butylperoxyisobutyrate, tert-butylperoxypivalate, diisopropylperoxydicarbonate, and azobis compounds such as azobisisobutyronitrile.

Examples of suitable suspending agents include cellulose derivatives such as methyl cellulose, ethyl cellulose, and hydroxypropylmethyl cellulose, and partial saponification products of polyvinyl alcohol or polyvinyl acetate.

The appropriate polymerization temperature for the manufacture of the vinylidene chloride-methyl acrylate copolymer resin in accordance with the present invention is generally 20° C. to 100° C., preferably 40° C. to 90° C.

If necessary, filtration, washing with water, and drying are performed after completion of polymerization, and a powder-like resin is obtained.

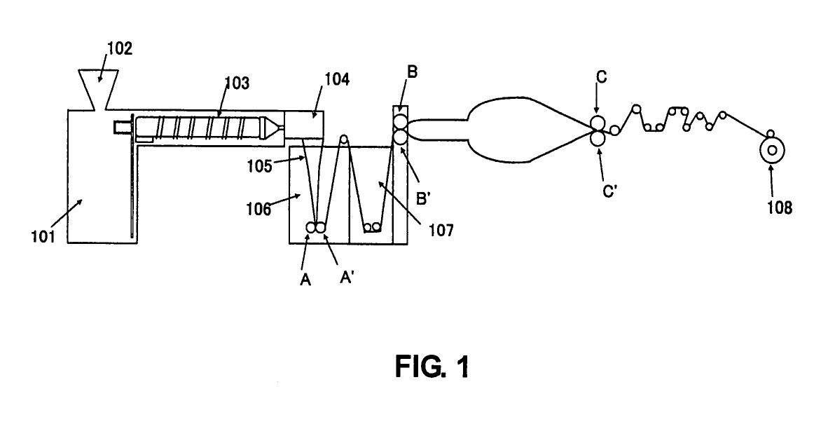

A biaxially stretched film of the vinylidene chloride-methyl acrylate copolymer resin in accordance with the present invention can be obtained by extruding the resin thus obtained in an apparatus for manufacturing biaxially stretched films. FIG. 1 is a schematic drawing of an apparatus for manufacturing biaxially stretched films. Referring to FIG. 1, the vinylidene chloride-methyl acrylate copolymer resin composition supplied from a hopper 102 of an extruder 101 is advanced by a screw 103, heated, kneaded, melted, and extruded from a slit portion of an annular die 104 mounted on a distal end of the extruder to obtain a cylindrical parison 105. The parison is rapidly cooled with cold water of the cooling tank 106, guided by the pinch rolls A, A′ to obtain a cylindrical shape, additionally heated in a warm water tank 107, and stretched and oriented in the circumferential direction and longitudinal direction of the cylinder by employing the volume of air sealed in the cylindrical film between pinch roll groups B, B′ and C, C′ and speed ratio between the pinch rolls B, B′ and C, C′. The stretched cylindrical film is two-layer folded to obtain a planar shape, wound on a winding roll 108, and then taken off by layers.

Extrusion evaluation in the below-described examples and comparative examples was performed using the apparatus shown in FIG. 1, and physical properties of the film obtained were evaluated. A single-screw extruder was used with D=120 mm and L/D=20, where D stands for a barrel diameter and L stands for a barrel length. The extrusion was carried out at an extrusion rate of 300 kg/hr.

### EXAMPLES

The present invention will be described below in greater detail based on examples and comparative examples. The weight-average molecular weight, extruder washing interval, die portion wiping interval, carbon foreign matter, film color tone (b value), oxygen transmission rate, water vapor transmission rate, HAZE after retort treatment, sliding ability, and laminate strength in the examples and comparative examples were evaluated by the following methods.

### (1) Weight-Average Molecular Weight

Weight-average molecular weight was found by gel permeation chromatography using polystyrene as a standard with the below-described devices and under the following conditions.

GPC: CL-10AD, manufactured by Shimadzu Corp.

Column: combined use of Shodex Asdahipak GS-710 7E and GS-310 7E, manufactured by Showa Denko KK.

Measurement temperature: 40° C.

Measurement concentration: a 0.3 wt. % sample was dissolved in a solution of triamide hexamethylphosphate.

### (2) Extruder Washing Interval

The test was conducted to evaluate thermal stability of resin with respect to retention of resin in the barrel or at the screw inside the extruder. Fine thermal degradation products or discoloration products were evaluated in a 2000 m² film with a thickness of 25 μm by the length of a continuous extrusion interval before 100 or more pieces of foreign matter with a side of 1 mm or more have flowed out. Where a large quantity of foreign matter flows out, the film production process has to be interrupted and thermal degradation products present inside the extruder have to be scraped off by replacing the resin with polyethylene or the like, whereby the production efficiency is decreased.

| Evaluation Symbol | Evaluation Criteria |
|---|---|
| [symbol] | 48 hr or more |
| ∘ | 24 hr or more and less than 48 hr |
| Δ | 6 hr or more and less than 24 hr |
| x | less than 6 hr |

### (3) Die Portion Wiping Interval

The test was conducted to evaluate thermal stability of resin with respect to retention of resin inside the die. Where sliding ability of the wall surface inside the die and the molten resin is poor, the retained resin is thermally degraded and adheres inside the die. In the worst cases, thick spots or streaks of film are generated. Where continuous streak-like contamination occurs and the thick and thin spots take 10% or more, the extruder has to be stopped and the die has to be disassembled and wiped, whereby the production efficiency is reduced significantly. The length of continuous extrusion interval till such state is assumed was evaluated.

| Evaluation Symbol | Evaluation Criteria |
|---|---|
| [symbol] | 1000 hr or more |
| ∘ | 500 hr or more and less than 1000 hr |
| Δ | 100 hr or more and less than 500 hr |
| x | less than 100 hr |

### (4) Carbon Foreign Matter

Where carbon (carbides) that appeared due to resin retention inside the extruder spontaneously peel off and flow out, it becomes carbon foreign matter. When large carbon foreign matter (black) flows out onto the film, problems are associated with product quality and the film has to be cut to remove the foreign matter and spliced. The number of pieces of carbon foreign matter with a size of 1 mm square or more was counted in a 2000 m² film with a thickness of 25 μm and evaluated as follows.

| Evaluation Symbol | Evaluation Criteria |
|---|---|
| [symbol] | 0 |
| ∘ | 1 or more and less than 5 |
| Δ | 5 or more and less than 10 |
| x | 10 or more |

### (5) Film Color Tone (b Value)

Film color tone is an indicator of resin thermal degradation. The larger is the b value, the larger is the degree of yellowing of the film and the more severe is the resin thermal degradation. Measurements were conducted under conditions of 23° C., 50% RH in a reflection mode of a color meter (Z-300A, manufactured by Nippon Denshoku Kogyo KK). A sample was prepared by laminating six films each having a thickness of 25 μm, and measurements were performed at a thickness of 150 μm.

| Evaluation Symbol | Evaluation Criteria |
|---|---|
| [symbol] | 0 or more and less than 2.0 |
| ∘ | 2.0 or more and less than 3.0 |
| Δ | 3.0 or more and less than 4.0 |
| x | 4.0 or more |

### (6) Oxygen Transmission Rate (OTR)

Oxygen transmission rate was measured according to ASTM D-3985. The measurements were carried out using Mocon OX-TRAN 2/20 at 23° C. and 65% RH by employing a film with a thickness of 25 μm.

| Evaluation Symbol | Evaluation Criteria |
|---|---|
| [symbol] | 50 mL · μm/m² · day · MPa ≦ OTR ≦ 400 mL · |
| | μm/m² · day · MPa |
| Δ | 400 mL · μm/m² · day · MPa < OTR ≦ 1000 mL · |
| | μm/m² · day · MPa |

### (7) Water Vapor Transmission Rate (WVTR)

Water vapor transmission rate was measured according to ASTM F-1249. The measurements were carried out using Mocon PERMATRAN-W200 at 38° C. and 90% RH by employing a film with a thickness of 25 μm.

| Evaluation Symbol | Evaluation Criteria |
|---|---|
| [symbol] | 5.0 g · μm/m² · day ≦ WVTR ≦ 40 g · μm/m² · |
| | day |
| Δ | 40 g · μm/m² · day < WVTR ≦ 100 g · μm/m² · |
| | day |

(8) HAZE after Retort Treatment

HAZE after retort treatment was measured according to ASTM D-1003. The haze of a film with a thickness of 25 μm that was subjected to heat treatment under the following conditions prior to measurements was measured with a HAZE meter (Z-300A, manufactured by Nippon Denshoku Kogyo KK) at 23° C. and 50% RH.

Retort conditions: the film was fixed to a metal frame and immersed for 20 min in a hot water under pressurized hot water at 120° C., and then dried for 1 week at a room temperature.

| Evaluation Symbol | Evaluation Criteria |
|---|---|
| [symbol] | less than 7% |
| ∘ | 7% or more and less than 10% |
| Δ | 10% or more and less than 15% |
| x | 15% or more |

### (9) Sliding Ability

Sliding ability was measured according to ASTM D-1894.

Dynamic friction coefficient (pd) between the films with a thickness of 25 μm was measured under the conditions of 23° C. and 50% RH.

| Evaluation Symbol | Evaluation Criteria |
|---|---|
| [symbol] | less than 0.4 |
| ∘ | 0.4 or more and less than 0.6 |
| Δ | 0.6 or more and less than 0.8 |
| x | 0.8 or more |

### (10) Laminate Strength

The present film (thickness 25 μm) was used as a core material and a 0-Ny (biaxially stretched Nylon) film (Harden N1100-type, thickness 15 μm, manufactured by Toyobo Co., Ltd.) and an LLDPE film (Lix L6102-type, thickness 60 μm, manufactured by Toyobo Co., Ltd.) were laminated thereonto. The laminated film obtained was aged for 2 days at 40° C. and then for 14 days at room temperature. The laminate strength between the present film and the 0-Ny film was measured.

### (Other Lamination Conditions)

Speed: 100 m/min.
Film tension: 5 MPa.
Nip roll: 60° C.

### Drying: 70° C.×20 sec.

Coating method: gravure coat.
Adhesive: adhesives A515 and A50 (manufactured by Mitsui Takeda Chemical Industries, Ltd.) were mixed at a 10:1 ratio. The mixture was dissolved by using ethyl acetate as a solvent taken in a weight amount threefold that of the adhesive.
Dry weight: 4 g/m² (dry).

| | Evaluation Criteria |
|---|---|
| Evaluation Symbol | (measured values at a width of 15 mm) |
| [symbol] | 500 g or more |
| ∘ | 400 g or more and less than 500 g |
| Δ | 200 g or more and less than 400 g |
| x | less than 200 g |

### Example 1

A total of 120 parts of deionized water having 0.2 part parts of hydroxypropylmethyl cellulose dissolved therein was poured into a reactor equipped with a stirrer and provided with a glass lining on the inner surface. After stirring was started, the system was purged with nitrogen at 30° C., a mixture of 95 parts of vinylidene chloride monomer (VDC), 5 parts of methyl acrylate monomer (MA), and 1.0 part of t-butyl peroxy-2-ethyl hexanoate as a polymerization initiator was charged, and the temperature of the reactor was raised to 80° C. to start the polymerization. A slurry with reduced temperature was taken out in 8 hr. Water was separated from the obtained slurry with a centrifugal dewatering device, and the slurry was then dried for 24 hr in a hot-air drying apparatus at 80° C. to obtain a vinylidene chloride-methyl acrylate copolymer resin in the form of a powder.

The copolymer yield was 99%, the weight-average molecular weight was 70,000, and the final copolymer composition was VDC/MA=95.3/4.7. A resin composition was then obtained by compounding (a) ESO at 0.5 wt. %, (b) BHT at 0.025 wt. %, (c) vitamin E at 0.007 wt. %, (d) DLTDP at 0.02 wt. %, (e) EDTA-2Na at 0.004 wt. %, (f) erucic acid amide at 0.05 wt. %, and (g) silica at 0.015 wt. %, based on the total weight.

The resin composition was extruded into a film at an extrusion rate of 300 kg/hr by an inflation method illustrated by FIG. 1 and a film with a thickness of 25 μm was obtained. The film was then used as a core material and a 0-Ny film (thickness 15 μm) and an LLDPE film (thickness 60 μm) were laminated on both sides thereof.

### Example 2

Polymerization conditions were identical to those of Example 1, except that 0.8 part of t-butyl peroxy-2-ethyl hexanoate was used, polymerization temperature was 75° C., polymerization time was 10 hr, and the content ratios of additives were changed as follows: (b) BHT at 0.04 wt. %, (c) vitamin E at 0.014 wt. %, (d) DLTDP at 0.04 wt. %, and (e) EDTA-2Na at 0.01 wt. %.

In this case, the copolymer yield was 99%, the weight-average molecular weight was 79,000, and the final copolymer composition was VDC/MA=95.1/4.9. The resin was molded into a film in the same manner as in Example 1 by the inflation method illustrated by FIG. 1, followed by lamination.

### Example 3

Polymerization conditions were identical to those of Example 1, except that 95.8 parts of vinylidene chloride monomer (VDC), 4.2 parts of methyl acrylate monomer (MA), 0.9 part of t-butyl peroxy-2-ethyl hexanoate were used, polymerization temperature was 75° C., polymerization time was 10 hr, and the content ratios of additives were changed as follows: (a) ESO at 0.12 wt. %, (b) BHT at 0.03 wt. %, (c) vitamin E at 0.01 wt. %, (d) DLTDP at 0.08 wt. %, and (e) EDTA-2Na at 0.008 wt. %.

In this case, the copolymer yield was 99%, the weight-average molecular weight was 79,000, and the final copolymer composition was VDC/MA=95.9/4.1. The resin was molded into a film in the same manner as in Example 1 by the inflation method illustrated by FIG. 1, followed by lamination.

### Example 4

Polymerization conditions were identical to those of Example 1, except that 94 parts of vinylidene chloride monomer (VDC), 6 parts of methyl acrylate monomer (MA), 0.7 part of t-butyl peroxy-2-ethyl hexanoate were used, polymerization temperature was 75° C., polymerization time was 12 hr, and the content ratios of additives were changed as follows: (a) ESO at 0.12 wt. %, (b) BHT at 0.02 wt. %, (c) vitamin E at 0.02 wt. %, (d) DLTDP at 0.1 wt. %, and (e) EDTA-2Na at 0.006 wt. %.

In this case, the copolymer yield was 99%, the weight-average molecular weight was 79,000, and the final copolymer composition was VDC/MA=94.1/5.9. The resin was molded into a film in the same manner as in Example 1 by the inflation method illustrated by FIG. 1, followed by lamination.

### Example 5

Polymerization conditions were identical to those of Example 1, except that 2.0 parts of t-butyl peroxy-2-ethyl hexanoate were used, polymerization temperature was 80° C., polymerization time was 7 hr, and the content ratios of additives were changed as follows: (b) BHT at 0.006 wt. %, (c) vitamin E at 0.002 wt. %, (d) DLTDP at 0.006 wt. %, and (e) EDTA-2Na at 0.002 wt. %.

In this case, the copolymer yield was 99%, the weight-average molecular weight was 61,000, and the final copolymer composition was VDC/MA=95.3/4.7. The resin was molded into a film in the same manner as in Example 1 by the inflation method illustrated by FIG. 1, followed by lamination.

### Example 6

Polymerization conditions were identical to those of Example 1, except that 95.9 parts of vinylidene chloride monomer (VDC), 4.1 parts of methyl acrylate monomer (MA), 0.9 part of t-butyl peroxy-2-ethyl hexanoate were used, polymerization temperature was 75° C., polymerization time was 10 hr, and the content ratios of additives were changed as follows: (a) ESO at 0.9 wt. %, (b) BHT at 0.01 wt. %, (c) vitamin E at 0.004 wt. %, (d) DLTDP at 0.2 wt. %, and (e) EDTA-2Na at 0.02 wt. %.

In this case, the copolymer yield was 99%, the weight-average molecular weight was 79,000, and the final copolymer composition was VDC/MA=95.9/4.1. The resin was molded into a film in the same manner as in Example 1 by the inflation method illustrated by FIG. 1, followed by lamination.

### Example 7

Polymerization conditions were identical to those of Example 1, except that 94.4 parts of vinylidene chloride monomer (VDC), 5.6 parts of methyl acrylate monomer (MA), 0.75 part of t-butyl peroxy-2-ethyl hexanoate were used, polymerization temperature was 75° C., polymerization time was 12 hr, and the content ratios of additives were changed as follows: (a) ESO at 0.4 wt. %, (b) BHT at 0.025 wt. %, (c) vitamin E at 0.007 wt. %, (d) DLTDP at 0.02 wt. %, and (e) EDTA-2Na at 0.04 wt. %.

In this case, the copolymer yield was 99%, the weight-average molecular weight was 79,000, and the final copolymer composition was VDC/MA=94.5/5.5. The resin was molded into a film in the same manner as in Example 1 by the inflation method illustrated by FIG. 1, followed by lamination.

### Example 8

Polymerization conditions were identical to those of Example 1, except that the content ratio of (f) erucic acid amide was changed to 0.005 wt. % and that of (g) silica was changed to 0.09 wt %.

In this case, the copolymer yield was 99%, the weight-average molecular weight was 70,000, and the final copolymer composition was VDC/MA=95.2/4.8. The resin was molded into a film in the same manner as in Example 1 by the inflation method illustrated by FIG. 1, followed by lamination.

### Example 9

Polymerization conditions were identical to those of Example 1, except that the content ratio of (f) erucic acid amide was changed to 0.14 wt. % and that of (g) silica was changed to 0.002 wt %.

In this case, the copolymer yield was 99%, the weight-average molecular weight was 70,000, and the final copolymer composition was VDC/MA=95.2/4.8. The resin was molded into a film in the same manner as in Example 1 by the inflation method illustrated by FIG. 1, followed by lamination.

### Example 10

Polymerization conditions were identical to those of Example 1, except that the content ratio of (f) erucic acid amide was changed to 0.09 wt. % and no (g) silica was added.

In this case, the copolymer yield was 99%, the weight-average molecular weight was 70,000, and the final copolymer composition was VDC/MA=95.2/4.8. The resin was molded into a film in the same manner as in Example 1 by the inflation method illustrated by FIG. 1, followed by lamination.

### Example 11

Polymerization conditions were identical to those of Example 1, except that the content ratio of (f) erucic acid amide was changed to 0.011 wt. % and that of (g) silica was changed to 0.11 wt %.

In this case, the copolymer yield was 99%, the weight-average molecular weight was 70,000, and the final copolymer composition was VDC/MA=95.2/4.8. The resin was molded into a film in the same manner as in Example 1 by the inflation method illustrated by FIG. 1, followed by lamination.

### Comparative Example 1

Polymerization conditions were identical to those of Example 1, except that 96.4 parts of vinylidene chloride monomer (VDC), 3.6 parts of methyl acrylate monomer (MA), 2.2 parts of t-butyl peroxy-2-ethyl hexanoate were used, polymerization temperature was 80° C., polymerization time was 8 hr, and the content ratios of additives were changed as follows: (a) ESO at 0.9 wt. %, (b) BHT at 0.04 wt. %, (c) vitamin E at 0.04 wt. %, (d) DLTDP at 0.3 wt. %, and (e) EDTA-2Na at 0.04 wt. %.

In this case, the copolymer yield was 99%, the weight-average molecular weight was 61,000, and the final copolymer composition was VDC/MA=96.5/3.5. The resin was molded into a film in the same manner as in Example 1 by the inflation method illustrated by FIG. 1, followed by lamination.

### Comparative Example 2

Polymerization conditions were identical to those of Example 1, except that 93.4 parts of vinylidene chloride monomer (VDC), 6.6 parts of methyl acrylate monomer (MA), 1.8 part of t-butyl peroxy-2-ethyl hexanoate were used, polymerization temperature was 80° C., polymerization time was 10 hr, and the content ratios of additives were changed as follows: (a) ESO at 0.12 wt. % and (f) erucic acid amide at 0.07 wt. %.

In this case, the copolymer yield was 99%, the weight-average molecular weight was 61,000, and the final copolymer composition was VDC/MA=93.5/6.5. The resin was molded into a film in the same manner as in Example 1 by the inflation method illustrated by FIG. 1, followed by lamination.

### Comparative Example 3

Polymerization conditions were identical to those of Example 1, except that 94.5 parts of vinylidene chloride monomer (VDC), 5.5 parts of methyl acrylate monomer (MA), 0.75 part of t-butyl peroxy-2-ethyl hexanoate were used, polymerization temperature was 75° C., polymerization time was 12 hr, and the content ratios of additives were changed as follows: (a) ESO at 0.4 wt. %, (b) BHT at 0.04 wt. %, (c) vitamin E at 0.04 wt. %, (d) DLTDP at 0.3 wt. %, (e) EDTA-2Na at 0.04 wt. %, (f) erucic acid amide at 0.1 wt. %, and (g) silica at 0.002 wt %.

In this case, the copolymer yield was 99%, the weight-average molecular weight was 81,000, and the final copolymer composition was VDC/MA=94.5/5.5. The resin was molded into a film in the same manner as in Example 1 by the inflation method illustrated by FIG. 1, followed by lamination.

### Comparative Example 4

Polymerization conditions were identical to those of Example 1, except that 2.2 part of t-butyl peroxy-2-ethyl hexanoate were used, polymerization temperature was 80° C., and polymerization time was 7 hr.

In this case, the copolymer yield was 99%, the weight-average molecular weight was 59,000, and the final copolymer composition was VDC/MA=95.3/4.7. An attempt was made to extrude the resin composition by the inflation method illustrated by FIG. 1, but stretching was impossible because film strength was too low.

### Comparative Example 5

Polymerization conditions were identical to those of Example 1, except that 93.8 parts of vinylidene chloride monomer (VDC), 6.2 parts of methyl acrylate monomer (MA), 1.8 part of t-butyl peroxy-2-ethyl hexanoate were used, polymerization temperature was 80° C., polymerization time was 7 hr, and the content ratios of additives were changed as follows: (a) ESO at 0.08 wt. %, (b) BHT at 0.04 wt. %, (c) vitamin E at 0.04 wt. %, (d) DLTDP at 0.3 wt. %, (e) EDTA-2Na at 0.04 wt. %, and (f) erucic acid amide at 0.2 wt. %.

In this case, the copolymer yield was 99%, the weight-average molecular weight was 61,000, and the final copolymer composition was VDC/MA=94.1/5.9. The resin was molded into a film in the same manner as in Example 1 by the inflation method illustrated by FIG. 1, followed by lamination.

### Comparative Example 6

Polymerization conditions were identical to those of Example 1, except that 95.5 parts of vinylidene chloride monomer (VDC), 4.5 parts of methyl acrylate monomer (MA), 2.2 parts of t-butyl peroxy-2-ethyl hexanoate were used, polymerization temperature was 80° C., polymerization time was 7 hr, and the content ratios of additives were changed as follows: (a) ESO at 1.1 wt. %, (f) erucic acid amide at 0.01 wt. %, and no (g) silica was added.

In this case, the copolymer yield was 99%, the weight-average molecular weight was 61,000, and the final copolymer composition was VDC/MA=95.9/4.1. The resin was molded into a film in the same manner as in Example 1 by the inflation method illustrated by FIG. 1, followed by lamination.

### Comparative Example 7

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and no (b) BHT was added.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 8

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and (b) BHT at 0.1 wt.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 9

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and no (c) vitamin E was added.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 10

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and (c) vitamin E at 0.1 wt. %.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination. However, the film obtained by extrusion had a yellow color due to vitamin E and was not at a level enabling the use thereof as a product.

### Comparative Example 11

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and no (d) DLTDP was added.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 12

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and (d) DLTDP at 0.7 wt. %.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 13

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and no (e) EDTA-2Na was added.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 14

Polymerization conditions were identical to those of Example 1, except that 94.2 parts of vinylidene chloride monomer (VDC), 5.8 parts of methyl acrylate monomer (MA), 1.7 part of t-butyl peroxy-2-ethyl hexanoate were used, polymerization temperature was 80° C., polymerization time was 7 hr, and the content ratios of additives were changed as follows: (a) ESO at 0.4 wt. % and (e) EDTA-2Na at 0.1 wt. %.

In this case, the copolymer yield was 99%, the weight-average molecular weight was 61,000, and the final copolymer composition was VDC/MA=94.5/5.5. The resin was molded into a film in the same manner as in Example 1 by the inflation method illustrated by FIG. 1, followed by lamination.

### Comparative Example 15

Polymerization conditions were identical to those of Example 1, except that 97 parts of vinylidene chloride monomer (VDC), 3 parts of methyl acrylate monomer (MA), 0.6 part of t-butyl peroxy-2-ethyl hexanoate were used, polymerization temperature was 70° C., polymerization time was 15 hr, and the content ratios of additives were changed as follows: (a) ESO at 0.9 wt. %, (b) BHT at 0.04 wt. %, (c) vitamin E at 0.04 wt. %, (d) DLTDP at 0.3 wt. %, and (e) EDTA-2Na at 0.04 wt. %.

In this case, the copolymer yield was 99%, the weight-average molecular weight was 98,000, and the final copolymer composition was VDC/MA=97/3. The resin was molded into a film in the same manner as in Example 1 by the inflation method illustrated by FIG. 1, followed by lamination.

TABLE 1

| | PVDC-MA resin | | Additives (thermal stabilizers) | | | | | Lubricants | |
|---|---|---|---|---|---|---|---|---|---|
| | composition | | | | Vitamin | | EDTA- | Erucic | |
| | VDC/MA | Wt.-av. | ESO | BHT | E | DLTDP | 2Na | acid amide | Silica |
| | (wt. %) | mol. wt. (×10⁴) | (wt. %) | (wt. %) | (wt. %) | (wt. %) | (wt. %) | (wt. %) | (wt. %) |
| Example 1 | 95.3/4.7 | 7.0 | 0.50 | 0.025 | 0.007 | 0.02 | 0.004 | 0.05 | 0.015 |
| Example 2 | 95.1/4.9 | 7.9 | 0.50 | 0.04 | 0.014 | 0.04 | 0.01 | 0.05 | 0.015 |
| Example 3 | 95.9/4.1 | 7.9 | 0.12 | 0.03 | 0.01 | 0.08 | 0.008 | 0.05 | 0.015 |
| Example 4 | 94.1/5.9 | 7.9 | 0.12 | 0.02 | 0.02 | 0.1 | 0.006 | 0.05 | 0.015 |
| Example 5 | 95.3/4.7 | 6.1 | 0.50 | 0.006 | 0.002 | 0.006 | 0.002 | 0.05 | 0.015 |
| Example 6 | 95.9/4.1 | 7.9 | 0.90 | 0.01 | 0.004 | 0.2 | 0.02 | 0.05 | 0.015 |
| Example 7 | 94.5/5.5 | 7.9 | 0.40 | 0.025 | 0.007 | 0.02 | 0.04 | 0.05 | 0.015 |
| Example 8 | 95.2/4.8 | 7.0 | 0.50 | 0.025 | 0.007 | 0.02 | 0.004 | 0.005 | 0.09 |
| Example 9 | 95.5/4.8 | 7.0 | 0.50 | 0.025 | 0.007 | 0.02 | 0.004 | 0.14 | 0.002 |
| Example 10 | 95.2/4.8 | 7.0 | 0.50 | 0.025 | 0.007 | 0.02 | 0.004 | 0.09 | 0 |
| Example 11 | 95.2/4.8 | 7.0 | 0.50 | 0.025 | 0.007 | 0.02 | 0.004 | 0.011 | 0.11 |
| Comp. | 96.5/3.5 | 6.1 | 0.90 | 0.04 | 0.04 | 0.3 | 0.04 | 0.05 | 0.015 |
| Example 1 | | | | | | | | | |
| Comp. | 93.5/6.5 | 6.1 | 0.12 | 0.025 | 0.007 | 0.02 | 0.004 | 0.07 | 0.015 |
| Example 2 | | | | | | | | | |
| Comp. | 94.5/5.5 | 8.1 | 0.40 | 0.04 | 0.04 | 0.3 | 0.04 | 0.1 | 0.002 |
| Example 3 | | | | | | | | | |
| Comp. | 95.3/4.7 | 5.9 | 0.50 | 0.025 | 0.007 | 0.02 | 0.004 | 0.05 | 0.015 |
| Example 4 | | | | | | | | | |
| Comp. | 94.1/5.9 | 6.1 | 0.08 | 0.04 | 0.04 | 0.3 | 0.04 | 0.2 | 0.015 |
| Example 5 | | | | | | | | | |
| Comp. | 95.9/4.1 | 6.1 | 1.1 | 0.025 | 0.007 | 0.02 | 0.004 | 0.01 | 0 |
| Example 6 | | | | | | | | | |
| Comp. | 94.5/5.5 | 6.1 | 0.40 | 0 | 0.007 | 0.02 | 0.004 | 0.05 | 0.015 |
| Example 7 | | | | | | | | | |
| Comp. | 94.5/5.5 | 6.1 | 0.40 | 0.1 | 0.007 | 0.02 | 0.004 | 0.05 | 0.015 |
| Example 8 | | | | | | | | | |
| Comp. | 94.5/5.5 | 6.1 | 0.40 | 0.025 | 0 | 0.02 | 0.004 | 0.05 | 0.015 |
| Example 9 | | | | | | | | | |
| Comp. | 94.5/5.5 | 6.1 | 0.40 | 0.025 | 0.1 | 0.02 | 0.004 | 0.05 | 0.015 |
| Example 10 | | | | | | | | | |
| Comp. | 94.5/5.5 | 6.1 | 0.40 | 0.025 | 0.007 | 0 | 0.004 | 0.05 | 0.015 |
| Example 11 | | | | | | | | | |
| Comp. | 94.5/5.5 | 6.1 | 0.40 | 0.025 | 0.007 | 0.7 | 0.004 | 0.05 | 0.015 |
| Example 12 | | | | | | | | | |
| Comp. | 94.5/5.5 | 6.1 | 0.40 | 0.025 | 0.007 | 0.02 | 0 | 0.05 | 0.015 |
| Example 13 | | | | | | | | | |
| Comp. | 94.5/5.5 | 6.1 | 0.40 | 0.025 | 0.007 | 0.02 | 0.1 | 0.05 | 0.015 |
| Example 14 | | | | | | | | | |
| Comp. | 97/3 | 9.8 | 0.90 | 0.04 | 0.04 | 0.3 | 0.04 | 0.05 | 0.015 |
| Example 15 | | | | | | | | | |

Thermal stability

| | |
|---|---|
| Die | Film properties |

| | Extruder | portion | Carbon | Film color | | | HAZE | | |
|---|---|---|---|---|---|---|---|---|---|
| | washing | wiping | foreign | tone | | | (after | Sliding | Laminate |
| | interval | interval | matter | (b value) | OTR | WVTR | retort) | ability | strength |
| Example 1 | [symbol] | [symbol] | [symbol] | [symbol] | [symbol] | [symbol] | [symbol] | [symbol] | [symbol] |
| Example 2 | ∘ | ∘ | ∘ | ∘ | [symbol] | [symbol] | [symbol] | [symbol] | [symbol] |
| Example 3 | ∘ | ∘ | ∘ | ∘ | [symbol] | [symbol] | [symbol] | [symbol] | [symbol] |
| Example 4 | ∘ | ∘ | ∘ | ∘ | [symbol] | [symbol] | [symbol] | [symbol] | [symbol] |
| Example 5 | [symbol] | [symbol] | [symbol] | [symbol] | [symbol] | [symbol] | [symbol] | [symbol] | [symbol] |
| Example 6 | ∘ | ∘ | ∘ | ∘ | [symbol] | [symbol] | [symbol] | [symbol] | [symbol] |
| Example 7 | [symbol] | [symbol] | [symbol] | [symbol] | [symbol] | [symbol] | [symbol] | [symbol] | [symbol] |
| Example 8 | [symbol] | [symbol] | [symbol] | [symbol] | [symbol] | [symbol] | [symbol] | Δ | [symbol] |
| Example 9 | [symbol] | [symbol] | [symbol] | [symbol] | [symbol] | [symbol] | [symbol] | [symbol] | Δ |
| Example 10 | [symbol] | [symbol] | [symbol] | [symbol] | [symbol] | [symbol] | [symbol] | Δ | [symbol] |
| Example 11 | [symbol] | [symbol] | [symbol] | [symbol] | [symbol] | [symbol] | ∘ | [symbol] | [symbol] |
| Comp. | x | x | Δ | Δ | [symbol] | [symbol] | ∘ | [symbol] | [symbol] |
| Example 1 | | | | | | | | | |
| Comp. | ∘ | ∘ | ∘ | ∘ | Δ | Δ | [symbol] | [symbol] | ∘ |
| Example 2 | | | | | | | | | |
| Comp. | Δ | Δ | Δ | Δ | [symbol] | [symbol] | ∘ | ∘ | ∘ |
| Example 3 | | | | | | | | | |
| Comp. | Film could not be produced because strength of the | | | | | | | | |
| Example 4 | film was insufficient during stretching | | | | | | | | |
| Comp. | Δ | Δ | Δ | Δ | [symbol] | [symbol] | ∘ | [symbol] | x |
| Example 5 | | | | | | | | | |
| Comp. | [symbol] | [symbol] | [symbol] | [symbol] | Δ | Δ | [symbol] | x | [symbol] |
| Example 6 | | | | | | | | | |
| Comp. | Δ | Δ | Δ | x | [symbol] | [symbol] | [symbol] | [symbol] | [symbol] |
| Example 7 | | | | | | | | | |
| Comp. | [symbol] | [symbol] | [symbol] | [symbol] | [symbol] | [symbol] | x | [symbol] | [symbol] |
| Example 8 | | | | | | | | | |
| Comp. | Δ | Δ | Δ | x | [symbol] | [symbol] | [symbol] | [symbol] | [symbol] |
| Example 9 | | | | | | | | | |
| Comp. | [symbol] | [symbol] | [symbol] | x | [symbol] | [symbol] | [symbol] | [symbol] | [symbol] |
| Example 10 | | | | | | | | | |
| Comp. | Δ | x | Δ | Δ | [symbol] | [symbol] | [symbol] | [symbol] | [symbol] |
| Example 11 | | | | | | | | | |
| Comp. | [symbol] | [symbol] | [symbol] | [symbol] | [symbol] | [symbol] | x | [symbol] | [symbol] |
| Example 12 | | | | | | | | | |
| Comp. | Δ | Δ | x | Δ | [symbol] | [symbol] | [symbol] | [symbol] | [symbol] |
| Example 13 | | | | | | | | | |
| Comp. | [symbol] | [symbol] | [symbol] | [symbol] | [symbol] | [symbol] | x | [symbol] | [symbol] |
| Example 14 | | | | | | | | | |
| Comp. | x | x | x | x | [symbol] | [symbol] | ∘ | [symbol] | [symbol] |
| Example 15 | | | | | | | | | |

The vinylidene chloride-methyl acrylate copolymer resin composition in accordance with the present invention has excellent thermal stability and is suitable for producing films by extrusion at a high extrusion rate. A biaxially stretched film obtained by stretching the resin composition was confirmed to excel in barrier properties, transparency, and suitability for lamination.

The vinylidene chloride-methyl acrylate copolymer resin composition in accordance with the present invention demonstrates excellent thermal stability during film formation by extrusion and can be produced with excellent productivity. Furthermore, the stretched film composed of the resin is advantageous as a barrier material for laminates as packaging materials for medical products and food.

1. A vinylidene chloride-methyl acrylate copolymer resin composition comprising a vinylidene chloride-methyl acrylate copolymer resin that has a content ratio of methyl acrylate component of no less than 4 wt. % and no more than 6 wt. % and a weight-average molecular weight, determined by gel permeation chromatography, of no less than 60,000 and no more than 80,000, and comprising as additives:
(a) an epoxidized vegetable oil at no less than 0.1 wt. % and no more than 1.0 wt. %;
(b) 2,6-di-tert-butyl-4-methylphenol at no less than 0.005 wt. % and no more than 0.05 wt. %;
(c) dl-α-tocopherol at no less than 0.001 wt. % and no more than 0.05 wt. %;
(d) a thiodifatty acid dialkyl ester at no less than 0.005 wt. % and no more than 0.5 wt. %; and
(e) an ethylenediaminetetraacetic acid salt at no less than 0.001 wt. % and no more than 0.05 wt. %.

2. The resin composition according to claim 1, wherein the epoxidized vegetable oil, the additive (a), is selected from epoxidized linseed oil, epoxidized soybean oil, and mixtures thereof.

3. The resin composition according to claim 1, wherein the thiodifatty acid dialkyl ester, the additive (d), is selected from dilauryl thiodipropionate, distearyl thiodipropionate, and mixtures thereof.

4. The resin composition according to claim 1, wherein the ethylenediaminetetraacetic acid salt, the additive (e), is disodium salt of ethylenediaminetetraacetic acid.

5. The resin composition according to claim 1, further comprising as additives:
(f) a fatty acid amide at no less than 0.01 wt. % and no more than 0.1 wt. %; and
(g) an inorganic lubricant at no less than 0.001 wt. % and no more than 0.1 wt. %.

6. A biaxially stretched film of vinylidene chloride-methyl acrylate copolymer that is obtained by stretching the resin composition according to claim 1, wherein
an oxygen transmission rate is no less than 50 mL·μm/m²·day·MPa and no more than 400 mL·μm/m²·day·MPa; and
a water vapor transmission rate is no less than 5 g·μm/m²·day and no more than 40 g·μm/m²·day.

7. A biaxially stretched film of vinylidene chloride-methyl acrylate copolymer that is obtained by stretching the resin composition according to claim 1, wherein
a HAZE value of the biaxially stretched film with a thickness of 25 μm is less than 10% after the film is subjected to retort treatment.

8. A multilayer structure comprising at least one layer of the biaxially stretched film according to claim 6.

9. The multilayer structure according to claim 8, wherein the structure is a film or a sheet.

10. A multilayer structure comprising at least one layer of the biaxially stretched film according to claim 7.

11. The multilayer structure according to claim 10, wherein the structure is a film or a sheet.
